(19) United States
(12) Patent Application Publication
(10) Pub. No.: US 2014/0045003 A1
(43) Pub. Date: Feb. 13, 2014

(54) HYBRID-TYPE RECHARGEABLE BATTERY MODULE

(71) Applicant: Compal Electronics, Inc, Taipei City (TW)

(72) Inventors: Chien-Lee LIU, Taipei City (TW); Chi-Ming LAN, Taipei City (TW)

(73) Assignee: Compal Electronics, Inc, Taipei City (TW)

(21) Appl. No.: 13/963,854

(22) Filed: Aug. 9, 2013

Related U.S. Application Data
(60) Provisional application No. 61/682,300, filed on Aug. 12, 2012.

(51) Int. Cl. H01M 10/44

(52) U.S. Cl. CPC H01M 10/441
USPC 429/61

(57) ABSTRACT

Disclosed herein is a hybrid-type rechargeable battery module that includes a first cell block, a second cell block, a first switch, a second switch and a control unit. The control unit is configured to obtain the statuses of the first and second cell blocks and control the charging/discharging process of the first and second cell blocks. The first switch is electrically connected to the first cell block and the control unit so as to use the control unit to allow the first cell block to enter a discharging condition based on a difference value between the first and second electric capacities. The second switch is electrically connected to the second cell block and the control unit so as to use the control unit to allow the second cell block to enter a discharging condition based on the difference value between the first and second electric capacities.

### RELATED APPLICATIONS

This application claims priority to U.S. Provisional Application No. 61/682,300, filed Aug. 12, 2012 the entirety of which is herein incorporated by reference.

### BACKGROUND

1. Technical Field The present disclosure relates to a rechargeable battery module, and more particularly, a hybrid-type rechargeable battery module.

2. Description of Related Art

In recent years, new electronic products (e.g., notebooks, smart phones, tablets, etc.) with novel functions have been constantly entering the market. Concerning portability, the electronic products like cell phones and the notebooks are often equipped with rechargeable batteries.

Generally, rechargeable batteries have certain electrochemical characteristics: reversible chemical reaction and the convertible electric/chemical energy under an external electric source. As such, a discharged battery is able to return to the original electric/chemical condition. To the contrary, if the chemical reaction in a battery is irreversible, the battery (e.g., a dry cell) cannot function as a rechargeable battery.

When several batteries are serially connected for charging, further carefulness is required in that temperature and lifetime of the batteries vary with each other, which may cause minor terminal voltage differences among the batteries. With more of the serially connected batteries, the differences among the terminal voltages become larger, and are more likely to damage the batteries.

In view of the foregoing, there exist problems and disadvantages in the art that needs further improvement, but those skilled in the art sought vainly for a solution. There is an urgent need to detect the swelling of the battery to solve or circumvent above problems and disadvantages.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a hybrid-type rechargeable battery module so as to overcome the problems that have faced the prior art.

The rechargeable battery module according to the present disclosure comprises a first cell block, a second cell block, a control unit, a first switch and a second switch. The first cell block has a first electric capacity and comprises a plurality of various first battery cells; the second cell block has a second electric capacity and comprises a plurality of second battery cells; the control unit is electrically connected to the first cell block and the second cell block, configured to obtain statuses of the first cell block and the second cell block, and configured to control a charging/discharging process of the first cell block and the second cell block; the first switch is electrically connected to the first cell block and the control unit so as to use the control unit to allow the first cell block s to enter the discharging condition based on a difference electric capacity of the first cell block and the second cell block; the second switch is electrically connected to the second cell block and the control unit so as to use the control unit to allow the second cell block to enter the discharging condition based on a difference electric capacity of the first cell block and the second cell block.

In one embodiment, the second cell block comprises the plurality of various second battery cells.

In one embodiment, when the difference value is greater than a set range, and when the voltage of the first cell block is greater than the voltage of the second cell block, the control unit turns on the first switch so as to allow the first cell block to enter the discharging condition.

In one embodiment, the first cell block remains in the discharging condition until the control unit determines that the difference value is less than set range, and then the control unit turns off the first switch so as to allow the rechargeable battery module to resume a charging/discharging process.

In one embodiment, when the difference value is greater than the set range, and when the voltage of the first cell block is greater than a setting, the control unit turns on the first switch so as to allow the first cell block to enter the discharging condition.

In one embodiment, the first cell block remains in the discharging condition until the control unit determines that the difference value is less than the set range and the voltage of the first cell block is less than a setting, and then the control unit turns off the first switch so as to allow the rechargeable battery module to resume a charging/discharging process.

In one embodiment, when the control unit determines that the voltage of the first cell block is less than a first setting and when the voltage of the second cell block is less than a second setting, the control unit does not turn on the second switch, wherein the second setting is a maximum voltage safe value of the second cell block.

In one embodiment, when the control unit determines that the voltage of the first cell block is less than a first setting, the difference value is greater than a set range, and the voltage of the second cell block is greater than a second setting, the control unit turns on the second switch, so as to allow the first cell block to enter the discharging condition.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

1. Avoiding the damages resulted from the inconsistent statuses of different cell blocks; and

2. Balancing the electric quantity of each cell block.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram illustrating a hybrid-type rechargeable battery module according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

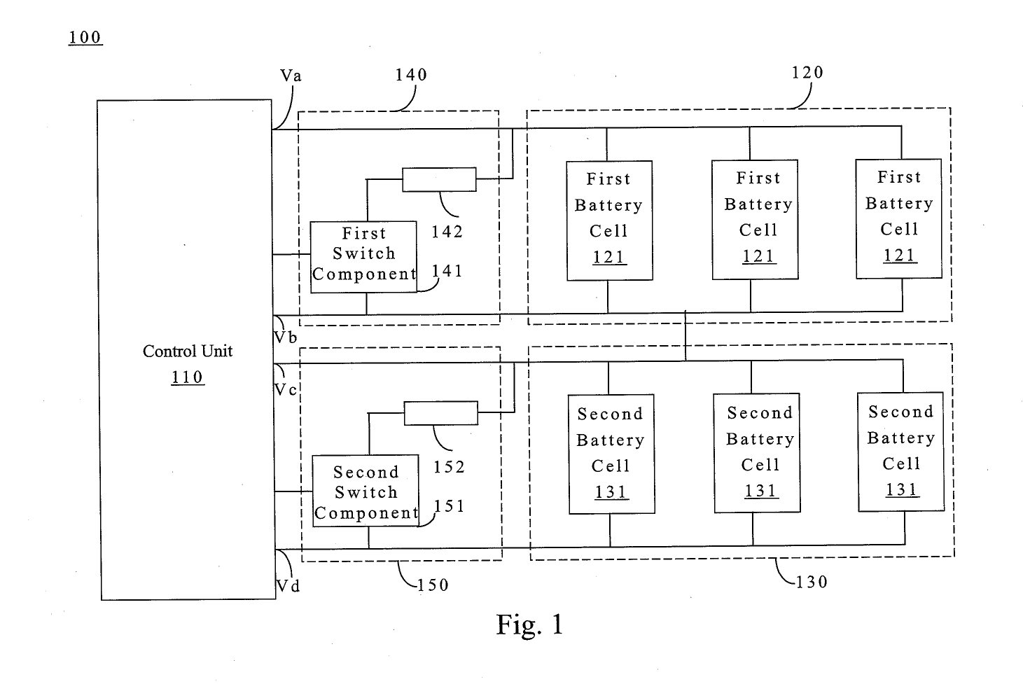

FIG. 1 is a block diagram illustrating a hybrid-type rechargeable battery module 100 according to one embodiment of the present disclosure. AS illustrated in FIG. 1, the rechargeable battery module 100 comprises a control unit 110, a first cell block 120, a second cell block 130, a first switch 140 and a second switch 150. In structure, the control unit 110 is electrically connected to the first cell block 120 and the second cell block 130, the first switch 140 and the second switch 150 are respectively electrically connected to the first cell block 120 and the second cell block 130 and both are electrically connected to the control unit 110. In implementation, the control unit 110 can be a built-in controller to the battery, a controller embedded in the system, a comparator circuit or other processing unit; persons having ordinary skill in the art when may flexibly select a suitable arrangement depending on actual needs. The first cell block 120 comprises a plurality of first battery cells 121 therewithin, and the second cell block 130 comprises a plurality of second battery cells 131 therewithin. The first cell block 120 has a first electric capacity, and the second cell block 130 has a second electric capacity. To fit the exterior design of the electronic products, the plurality of first battery cells 121 and the plurality of second battery cells 131 within the first cell block 120 and the second cell block 130 has more than two different specifications such that the rechargeable battery module 100 may give different appearance to fit the exterior design of the electronic device. Although the first cell block 120 and the second cell block 130 have various battery cells, an difference electric capacity between the is first cell block and the second cell block shall be within a set range so as to provide a safe charging process. Depending on the product designs, when the first battery cells 121 within the first cell block 120 have more than two specifications, the second battery cells 131 within the second cell block 130 may have the same specification. As used herein, by the phrase “the first battery cells 121 within the first cell block 120 has more than two specifications,” it is meant that the first cell block 120 has more than two first battery cells 121 of different electric capacities. Similarly, by the phrase “the second battery cells 131 within the second cell block 130 has more than two specifications,” it is meant that the first cell block 130 has more than two second battery cells 131 of different electric capacities.

In operation, the control unit 110 is configured to obtain the statuses of the first cell block 120 and the second cell block 130, and is configured to control a charging/discharging process of the first cell block 120 and the second cell block 130; said charging/discharging process includes a charging process and a discharging process; moreover, the control unit 110 is configured to control the first switch 140 and the second switch 150 based on the statuses of the first cell block 120 and the second cell block 130, so as to control the first switch 140 and the second switch 150, such that at least one of the first cell block 120 and the second cell block 130 enters the discharging condition, thereby avoiding the damage to the battery module, which is caused by the excess status difference between the first cell block 120 and the second cell block 130.

Specifically, during the charging process of the rechargeable battery module 100, the control unit 110 reads the voltage of the first cell block 120 (that is, the potential difference between potential Va and potential Vb) and the voltage of the second cell block 130 (that is, the potential difference between potential Vc and potential Vd), and when the voltage of first cell block 120 is greater than a setting, and the difference electric capacity between the first cell block and the second cell block is greater than a set range, the control unit 110 turns on the first switch 140 that is electrically connected to the first cell block 120 so as to allow the first cell block 120 to enter the discharging condition, and under the discharging condition, the control unit 110 stops the above-mentioned charging/discharging process. In practice, the control unit 110 may command the charger to stop the charging/discharging process with respect to the first cell block 120 and the second cell block 130, such that it is different from the discharging condition after the first switch 140 and the second switch 150 are turned on. In the present embodiment, said setting is the maximum voltage safe value of the first cell block 120.

Next, when the voltage of the first cell block 120 is less than the above-mentioned setting and the control unit 110 determines that the difference electric capacity between the first cell block and the second cell block is less than the set range, the control unit 110 turns off the first switch 140 so as to resume the charging/discharging process to the battery module 100, thereby balancing the electric quantity of each cell block during the charging process.

Briefly, in one embodiment, when the difference electric capacity between the first cell block and the second cell block is greater than the set range and the voltage of the first cell block 120 is greater than the voltage of the second cell block 130, the control unit 110 turns on the first switch 140 to allow the first cell block 120 to enter the discharging condition. In this case, the first cell block 120 remains in the discharging condition until the control unit 110 determines that the difference value is less than the set range, and then the control unit 110 turns off the first switch 140 so that the rechargeable battery module 100 resumes a charging/discharging process.

Depending on the designs of the products, when the voltage of the first cell block 120 does not exceed the setting but the difference electric capacity between the first cell block and the second cell block exceeds the set range, the control unit still turns on the first switch 140 such that the first cell block 120 enters the discharging condition. After the control unit 110 determines that the difference electric capacity between the first cell block and the second cell block is less than the set range, the control unit 110 turns off the first switch 140 so that the battery module 100 resumes the charging/discharging process. In this way, the electric quantities of the cell blocks are balanced during the charging process.

In another embodiment, during the charging process, when the control unit 110 determines that the voltage of the first cell block 120 is less than a first setting and the voltage of the second cell block 130 is less than a second setting, even though the difference electric capacity between the first cell block and the second cell block is greater than the set range, the control unit 110 will not turn on the second switch 150; rather it continues to perform the charging/discharging process of the battery module, so as to maintain the charging functionality of the battery module under a safe condition. The second setting is the maximum voltage safe value of the second cell block 130. When the voltage of the second cell block 130 is greater than the second setting, the control unit 110 will turn on the second switch 150 so that the second cell block 130 enters the discharging condition, and the control unit 110 stops the charging/discharging process. When the second cell block 130 enters the self-discharging process until the control unit 110 determines that the voltage of the second cell block 130 is less than a third setting, the control unit 110 will then turn off the second switch 150 such that the battery module 100 resumes the charging/discharging process. The main purpose of setting the first setting of the first cell block 120 is to address the problems associated with the sudden malfunction of a single cell block within the battery module, such that the other cell blocks may remain to proceed the normal charging/discharging process so that the battery module maintains its normal functionality.

In FIG. 1, the first switch 140 may comprise a first switch component 141 and a first transistor 142. In structure, the first switch component 141 and the first transistor 142 are is series connection, and when the first switch 140 is turned on, the first switch component 141 is in an on-state thereby forming a short-circuit, and hence, the first cell block 120 may discharge through the first transistor 142. To the contrary, when the first switch 140 is turned off, the first switch component 141 is cut-off to form a broken circuit, and hence, the first cell block 120 cannot discharge through the first transistor 142. Similarly, the second switch 150 may include a second switch component 151 and a second transistor 152, wherein the second switch component 151 and the transistor 152 are in series connection, and when the second switch 150 is turned on, the second switch component 151 is in an on-state thereby forming a short-circuit, and hence the second cell block 130 may discharge through the transistor 152. To the contrary, when the second switch 150 is turned off, the second switch component 151 is cut-off to form a broken circuit, and hence, the second cell block 130 cannot discharge through the transistor 152. In implementation, the first switch component 141 and the second switch component 151 may be a metal oxide semiconductor (MOS) or a bipolar junction transistors (BJT); persons having ordinary skill in the art may select suitable arrangement depending on actual needs.

Moreover, although in FIG. 1, only two cell blocks (that is, the first cell block 120 and the second cell block 130) are illustrated, the present invention is not limited thereto. In practice, persons having ordinary skill in the art may flexibly select the numbers of the cell block and corresponding switches depending on actual needs.

In view of the foregoing, the present disclosure may effectively avoid the damages resulted from the inconsistency of conditions of different cell blocks, so as to balance the electricity quantity of each cell blocks.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A hybrid-type rechargeable battery module, comprising:
a first cell block, having a first electric capacity and comprising a plurality of various first battery cells ;
a second cell block, having a second electric capacity and comprising a plurality of second battery cells;
a control unit, electrically connected to the first cell block and the second cell block, configured to obtain statuses of the first cell block and the second cell block, and configured to control a charging/discharging process of the first cell block and the second cell block;
a first switch, electrically connected to the first cell block and the control unit so as to use the control unit to allow the first cell block to enter a discharging condition based on a difference electric capacity between the first is cell block and the second cell block; and
a second switch, electrically connected to the second cell block and the control unit so as to use the control unit to allow the second cell block to enter a discharging condition based on the difference electric capacity between the first cell block and the second cell block.

2. The rechargeable battery module according to claim 1, wherein the second cell block comprises the plurality of various second battery cells.

3. The rechargeable battery module according to claim 1, wherein when the difference value is greater than a set range, and the voltage of the first cell block is greater than the voltage of the second cell block, the control unit turns on the first switch so as to allow the first cell block to enter the discharging condition.

4. The rechargeable battery module according to claim 3, wherein the first cell block remains in the discharging condition until the control unit determines that the difference value is less than the set range, and then the control unit turns off the first switch so as to allow the rechargeable battery module to resume a charging/discharging process.

5. The rechargeable battery module according to claim 1, wherein when the difference value is greater than a set range and the voltage of the first cell block is greater than a setting, the control unit turns on the first switch so as to allow the first cell block to enter the discharging condition.

6. The rechargeable battery module according to claim 5, wherein the first cell block remains in the discharging condition until the control unit determines that the difference value is less than the set range and the voltage of the first cell block is less than a setting, and then the control unit turns off the first switch so as to allow the rechargeable battery module to resume a charging/discharging process.

7. The rechargeable battery module according to claim 1, wherein when the control unit determines that the voltage of the first cell block is less than a first setting and the voltage of the second cell block is less than a second setting, the control unit does not turn on the second switch, wherein the second setting is a maximum voltage safe value of the second cell block.

8. The rechargeable battery module according to claim 1, wherein when the control unit determines that the voltage of the first cell block is less than a first setting, the difference value is greater than a set range, and the voltage of the second cell block is greater than a second setting, the control unit turns on the second switch, so as to allow the first cell block to enter the discharging condition.
